(19) United States
(12) Patent Application Publication
(10) Pub. No.: US 2026/0019400 A1
(43) Pub. Date: Jan. 15, 2026

(54) DETECTING AND PREVENTING DUPLICATE NETWORK ADDRESSES

(71) Applicant: Juniper Networks, Inc., Sunnyvale, CA (US)

(72) Inventors: Ishan SAWHNEY, Bangalore (IN); Sheetal Pukhraj JANGEED, Bengaluru (IN)

(21) Appl. No.: 19/230,654

(22) Filed: Jun. 6, 2025

Related U.S. Application Data
(60) Provisional application No. 63/668,907, filed on Jul. 9, 2024.

(51) Int. Cl. H04L 61/30

(52) U.S. Cl. CPC H04L 61/3005

(57) ABSTRACT

A first network device may generate a neighbor solicitation packet that includes a first address and a first priority associated with the first network device. The first network device may provide the neighbor solicitation packet to a second network device associated with a second address and a second priority, wherein the second address is the same as the first address. The first network device may receive, from the second network device and when the first priority is greater than the second priority, a neighbor acknowledgement packet that acknowledges that the first address is to be utilized. Alternatively, the first network device may receive, from the second network device and when the first priority is less than the second priority, another neighbor solicitation packet that includes the second address and the second priority. When the second network device has a higher priority, the first network device may disable its own address.

### CROSS-REFERENCE TO RELATED APPLICATION

This patent application claims priority to U.S. Provisional Patent Application No. 63/668,907, filed on Jul. 9, 2024, and entitled “DETECTING AND PREVENTING DUPLICATE NETWORK ADDRESSES.” The disclosure of the prior application is considered part of and is incorporated by reference into this patent application.

### BACKGROUND

In a network, such as an Internet protocol version 6 (IPv6) network, duplicate address detection may be utilized to detect duplicate network (e.g., IPv6) addresses and to avoid using the duplicate network addresses. A network device detecting a duplicate network address may disable its own network address to reduce traffic impact in the network.

### SUMMARY

Some implementations described herein relate to a method. The method may include generating a neighbor solicitation packet that includes a first address and a first priority associated with a first network device. The method may include providing the neighbor solicitation packet to a second network device associated with a second address and a second priority, wherein the second address is the same as the first address. The method may include selectively receiving, from the second network device and when the first priority is greater than the second priority, a neighbor acknowledgement packet that acknowledges that the first address is to be utilized, or receiving, from the second network device and when the first priority is less than the second priority, another neighbor solicitation packet that includes the second address and the second priority.

Some implementations described herein relate to a first network device. The first network device may include one or more memories and one or more processors. The one or more processors may be configured to generate a neighbor solicitation packet that includes a first address and a first priority associated with the first network device. The one or more processors may be configured to provide the neighbor solicitation packet to a second network device associated with a second address and a second priority, wherein the second address is the same as the first address, the first network device is a sender network device, and the second network device is a receiver network device. The one or more processors may be configured to selectively receive, from the second network device and when the first priority is greater than the second priority, a neighbor acknowledgement packet that acknowledges that the first address is to be utilized, or receive, from the second network device and when the first priority is less than the second priority, another neighbor solicitation packet that includes the second address and the second priority.

Some implementations described herein relate to a non-transitory computer-readable medium that stores a set of instructions. The set of instructions, when executed by one or more processors of a first network device, may cause the first network device to generate a neighbor solicitation packet that includes a first address and a first priority associated with the first network device. The set of instructions, when executed by one or more processors of the first network device, may cause the first network device to provide the neighbor solicitation packet to a second network device associated with a second address and a second priority, wherein the second address is the same as the first address. The set of instructions, when executed by one or more processors of the first network device, may cause the first network device to selectively receive, from the second network device and when the first priority is greater than the second priority, a neighbor acknowledgement packet that acknowledges that the first address is to be utilized, and enable the first address based on receiving the neighbor acknowledgement packet from the second network device, or receive, from the second network device and when the first priority is less than the second priority, another neighbor solicitation packet that includes the second address and the second priority.

### BRIEF DESCRIPTION OF THE DRAWINGS

FIGS. 1A-1C are diagrams of an example associated with detecting and preventing duplicate network addresses.

FIG. 2 is a diagram of an example environment in which systems and/or methods described herein may be implemented.

FIGS. 3 and 4 are diagrams of example components of one or more devices of FIG. 2.

FIG. 5 is a flowchart of example processes for detecting and preventing duplicate network addresses.

### DETAILED DESCRIPTION

The following detailed description of example implementations refers to the accompanying drawings. The same reference numbers in different drawings may identify the same or similar elements.

Currently, after duplicate address detection has disabled a network address of a device, there is no mechanism that can automatically recover a device's network address even when the duplicate address detection issue is resolved. For example, a network device may support multiple host devices directly connected to the network device in a same network portion (e.g., an IPv6 subnet). An interface of the network device, that connects to the host devices, may detect network address duplication (e.g., due to some other host device in the same network using the same network address as the interface). In such a situation, the network device will disable the network address and will not enable the network address even when the duplication is resolved. However, the interface has to be manually disabled and enabled, or duplicate address detection has to be manually disabled, in order to reenable the network address and make the network device utilize the network address previously identified as a duplicate network address. Thus, current techniques for handling duplicate network addresses consume computing resources (e.g., processing resources, memory resources, communication resources, and/or the like), networking resources, and/or other resources associated with failing to automatically reenable a duplicate network address after the duplication is resolved, causing a prolonged impact to network traffic until a manual recovery is performed, requiring manual intervention that increases costs of unmanned sites, and/or the like.

Some implementations described herein include a network device that detects and prevents duplicate network addresses. For example, a first network device may generate a neighbor solicitation packet that includes a first address and a first priority associated with the first network device. The first network device may provide the neighbor solicitation packet to a second network device associated with a second address and a second priority, wherein the second address is the same as the first address. The first network device may receive, from the second network device and when the first priority is greater than the second priority, a neighbor acknowledgement packet that acknowledges that the first address is to be utilized. Alternatively, the first network device may receive, from the second network device and when the first priority is less than the second priority, another neighbor solicitation packet that includes the second address and the second priority.

In this way, a network device detects and prevents duplicate network addresses. For example, the network device may automatically recover a duplicate network address once the duplicate network address issue is resolved. The network device may provide a priority field (e.g., a flag or a bit) and/or a retry mechanism in a neighbor solicitation (NS) packet. A network device with a higher priority may utilize a network address (e.g., an IPv6 address) even if duplication exists based on priority values advertised in the priority field of the NS packet. A retry mechanism (e.g., a timer) may ensure that, if the duplicate address detection was temporary or transient in nature during initialization, the duplicate address detection process is reinitiated to recover the network address. The NS packet may be enhanced to support the priority field (e.g., to modify the duplicate address detection mechanism from a first-come-first-served basis to a priority basis) and/or the duplicate address detection mechanism may be enhanced to utilize the priority field. Thus, the network device may conserve computing resources, networking resources, and/or other resources that would have otherwise been consumed by requiring manual intervention, which increases costs for unmanned sites, failing to automatically reenable a duplicate network address after the duplication is resolved, causing a prolonged impact to network traffic until a manual recovery is performed, and/or the like.

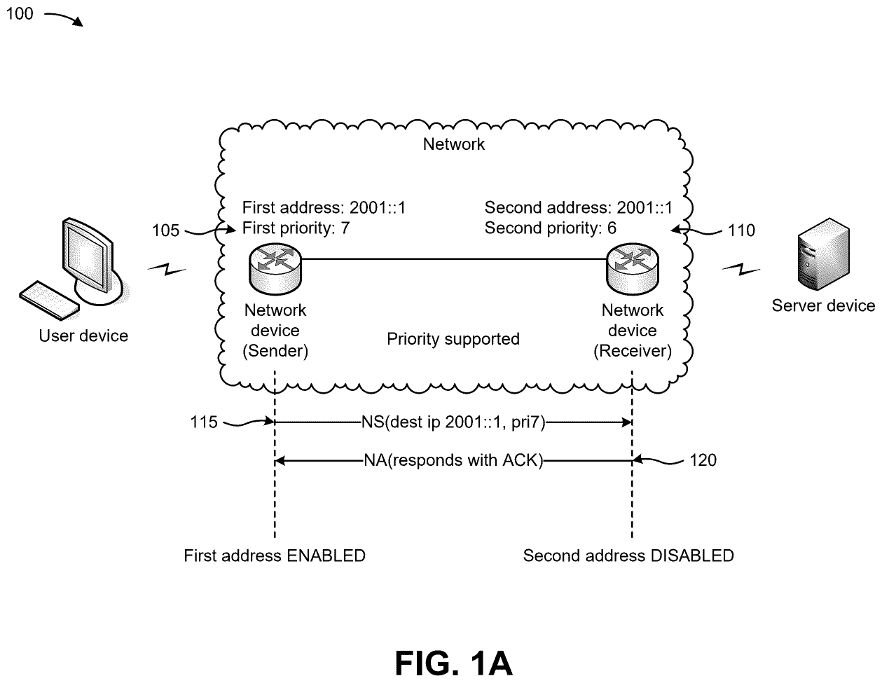

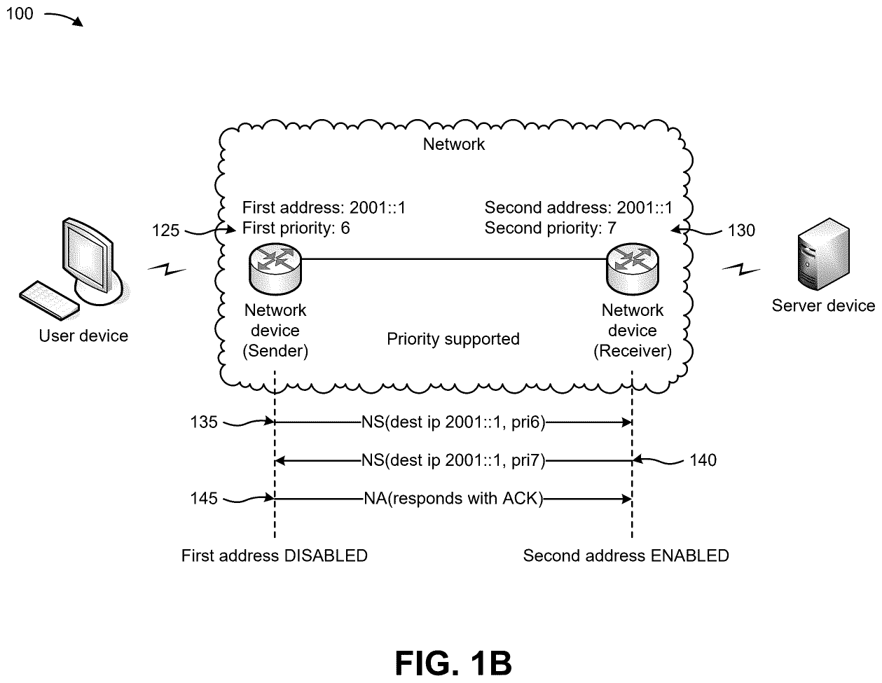

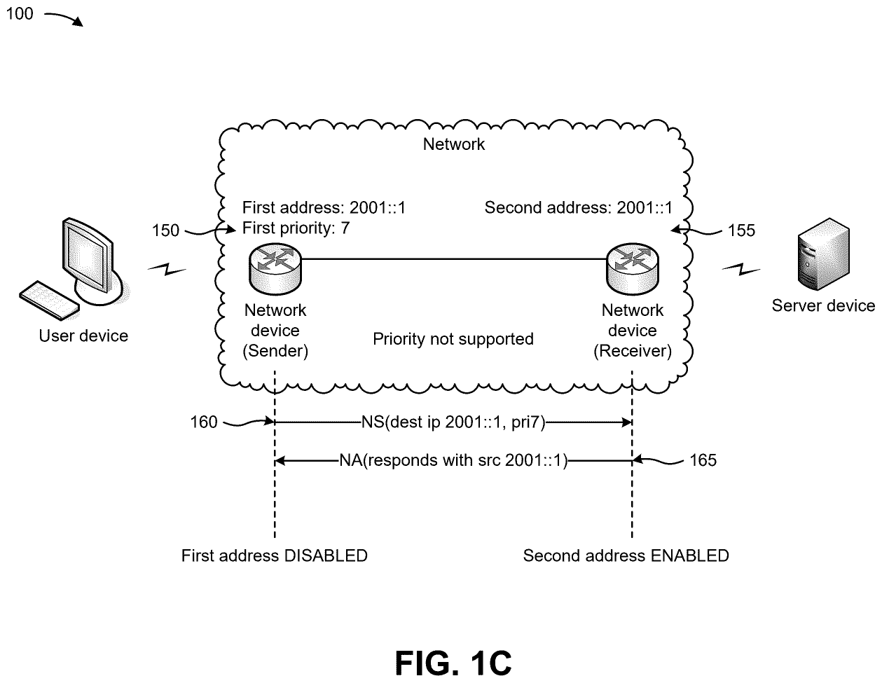

FIGS. 1A-1C are diagrams of an example 100 associated with detecting and preventing duplicate network addresses. As shown in FIGS. 1A-1C, the example 100 includes a user device, a server device, and a network with a plurality of network devices. Further details of the user device, the server device, the network, and the plurality of network devices are provided elsewhere herein.

As shown in FIG. 1A, a first network device and a second network device of the network may support priority for duplicate address detection. The first network device may be a sender network device, and the second network device may be a receiver network device. As shown by reference number 105, the first network device may be associated with a first address (e.g., “2000::1”), and may be associated with a first priority (e.g., “7”). As shown by reference number 110, the second network device may be associated with a second address (e.g., “2000::1”) that is the same as the first address, and may be associated with a second priority (e.g., “6”) that is less than the first priority.

As further shown in FIG. 1A, and by reference number 115, the first network device may generate an NS packet that includes the first address (e.g., “2001::1”) and the first priority (e.g., “7”), and may provide the NS packet to the second network device. The second network device may receive the NS packet from the first network device. In some implementations, the first address of the NS packet may conflict with the second address associated with the second network device. When the second network device receives the NS packet that includes the conflicting address (e.g., “2001::1”), the second network device may compare the first priority provided in the NS packet and the second priority associated with the second network device.

As further shown in FIG. 1A, and by reference number 120, if the first priority is greater than the second priority, the second network device may disable the second address and may generate a neighbor acknowledgement (NA) packet that acknowledges (ACK) that the first address may be utilized. The second network device may provide the NA packet to the first network device. Once the NA packet is received, the first network device may enable the first address and may provide NS packets with duplicate address detection to other peer network devices with the same duplication. The first network device may receive responses from the other peer network devices to determine whether to maintain enablement of the first address at the first network device.

As shown in FIG. 1B, the first network device and the second network device of the network may support priority for duplicate address detection. The first network device may be a sender network device, and the second network device may be a receiver network device. As shown by reference number 125, the first network device may be associated with a first address (e.g., “2000::1”), and may be associated with a first priority (e.g., “6”). As shown by reference number 130, the second network device may be associated with a second address (e.g., “2000::1”) that is the same as the first address, and may be associated with a second priority (e.g., “7”) that is greater than the first priority.

As further shown in FIG. 1B, and by reference number 135, the first network device may generate an NS packet that includes the first address (e.g., “2001::1”) and the first priority (e.g., “6”), and may provide the NS packet to the second network device. The second network device may receive the NS packet from the first network device. In some implementations, the first address of the NS packet may conflict with the second address associated with the second network device. When the second network device receives the NS packet that includes the conflicting address (e.g., “2001::1”), the second network device may compare the first priority and the second priority.

As further shown in FIG. 1B, and by reference number 140, if the first priority is less than the second priority, the second network device may generate another NS packet that includes the second address (e.g., “2001::1”) and the second priority (e.g., “7”), and may provide the other NS packet to the first network device. When the first network device receives the other NS packet that includes the conflicting address (e.g., “2001::1”), the first network device may compare the first priority and the second priority.

As further shown in FIG. 1B, and by reference number 145, if the first priority is less than the second priority, the first network device may disable the first address and may generate an NA packet that acknowledges that the second address may be utilized. The first network device may provide the NA packet to the second network device. Once the NA packet is received, the second network device may enable the second address and may provide NS packets with duplicate address detection to other peer network devices with the same duplication. The second network device may await responses from the other peer network devices to determine whether to maintain enablement of the second address at the second network device. If there are conflicting priorities (e.g., equivalent priorities for both network devices), the process steps described below in connection with FIG. 1C may be performed.

As shown in FIG. 1C, the first network device may support priority for duplicate address detection. However, the second network device may not support priority for duplicate address detection and may not be associated with a priority. The first network device may be a sender network device, and the second network device may be a receiver network device. As shown by reference number 150, the first network device may be associated with a first address (e.g., “2000::1”), and may be associated with a first priority (e.g., “7”). As shown by reference number 155, the second network device may be associated with a second address (e.g., “2000::1”) that is the same as the first address, and may not be associated with a priority.

As further shown in FIG. 1C, and by reference number 160, the first network device may generate an NS packet that includes the first address (e.g., “2001::1”) and the first priority (e.g., “7”), and may provide the NS packet to the second network device. The second network device may receive the NS packet from the first network device. In some implementations, the first address of the NS packet may conflict with the second address associated with the second network device.

As further shown in FIG. 1C, and by reference number 165, when the second network device receives the NS packet that includes the conflicting address (e.g., “2001::1”) and since the second network device does not support priority for duplicate address detection, the second network device may generate an NA packet that includes a duplicate address detection message (e.g., “src 2001::1”) and may provide the NA packet to the first network device. The first network device may disable the first address based on the NA packet and the duplicate address detection message. The second address may be enabled at the second network device, and the first address may be disabled at the first network device. In some implementations, after expiration of a timer value, the first network device may reinitiate duplicate address detection to determine whether to reenable the first address. If the duplication has been resolved (e.g., the second address is now different than the first address), the first network device may reenable the first address.

In this way, the network device detects and prevents duplicate network addresses. For example, the network device may automatically recover a duplicate network address once the duplicate network address issue is resolved. The network device may provide a priority field (e.g., a flag or a bit) and/or a retry mechanism in an NS packet. A network device with a higher priority may utilize a network address (e.g., an IPv6 address) even if duplication exists based on priority values advertised in the priority field of the NS packet. A retry mechanism (e.g., a timer) may ensure that, if the duplicate address detection was temporary or transient in nature during initialization, the duplicate address detection process is reinitiated to recover the network address. The NS packet may be enhanced to support the priority field (e.g., to modify the duplicate address detection mechanism from a first-come-first-served basis to a priority basis) and/or the duplicate address detection mechanism may be enhanced to utilize the priority field. Thus, the network device may conserve computing resources, networking resources, and/or other resources that would have otherwise been consumed by requiring manual intervention, which increases costs for unmanned sites, failing to automatically reenable a duplicate network address after the duplication is resolved, causing a prolonged impact to network traffic until a manual recovery is performed, and/or the like.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

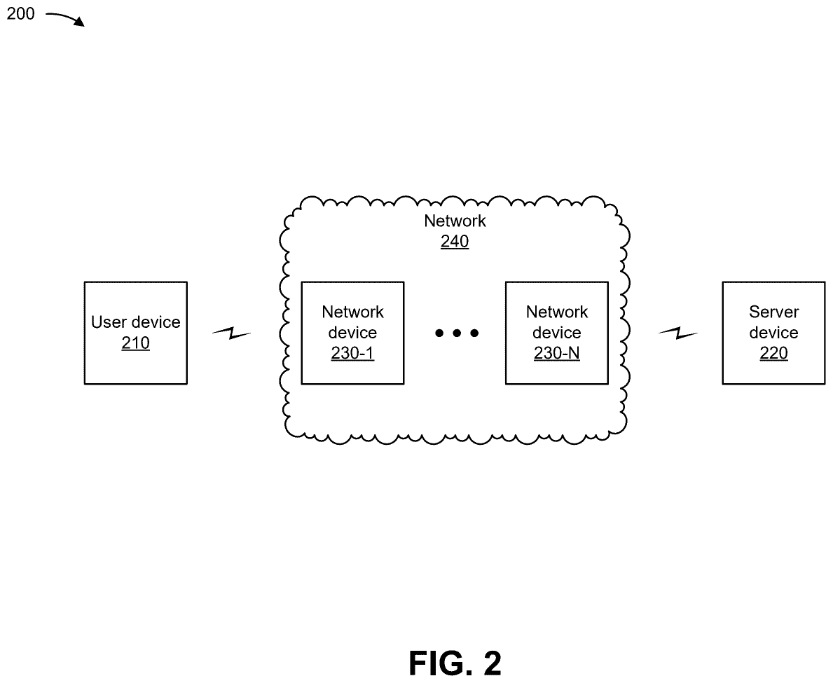

FIG. 2 is a diagram of an example environment 200 in which systems and/or methods described herein may be implemented. As shown in FIG. 2, environment 200 may include a user device 210, a server device 220, a group of network devices 230 (shown as network device 230-1 through network device 230-N), and a network 240. Devices of the environment 200 may interconnect via wired connections, wireless connections, or a combination of wired and wireless connections.

The user device 210 includes one or more devices capable of receiving, generating, storing, processing, and/or providing information, such as information described herein. For example, the user device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the user device 210 may receive network traffic from and/or may provide network traffic to other user devices 210 and/or the server device 220, via the network 240 (e.g., by routing packets using the network devices 230 as intermediaries).

The server device 220 may include one or more devices capable of receiving, generating, storing, processing, providing, and/or routing information, as described elsewhere herein. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. In some implementations, the server device 220 may include computing hardware used in a cloud computing environment.

The network device 230 includes one or more devices capable of receiving, processing, storing, routing, and/or providing traffic (e.g., a packet or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computer devices of a cloud computing environment or a data center. In some implementations, a group of network devices 230 may be a group of data center nodes that are used to route traffic flow through the network 240.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, a code division multiple access (CDMA) network, a public land mobile network (PLMN)), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

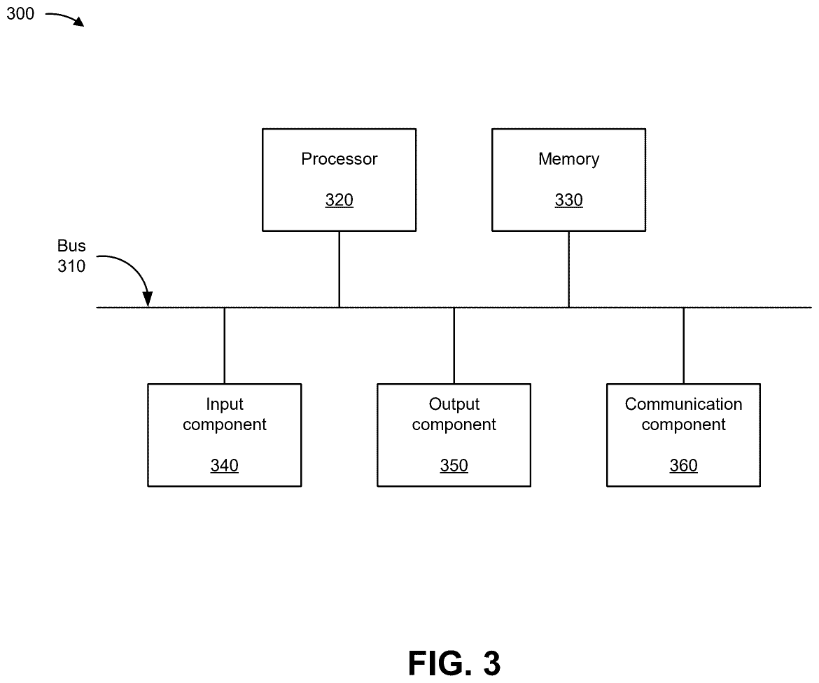

FIG. 3 is a diagram of example components of one or more devices of FIG. 2. The example components may be included in a device 300, which may correspond to the user device 210, the server device 220, and/or the network device 230. In some implementations, the user device 210, the server device 220, and/or the network device 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

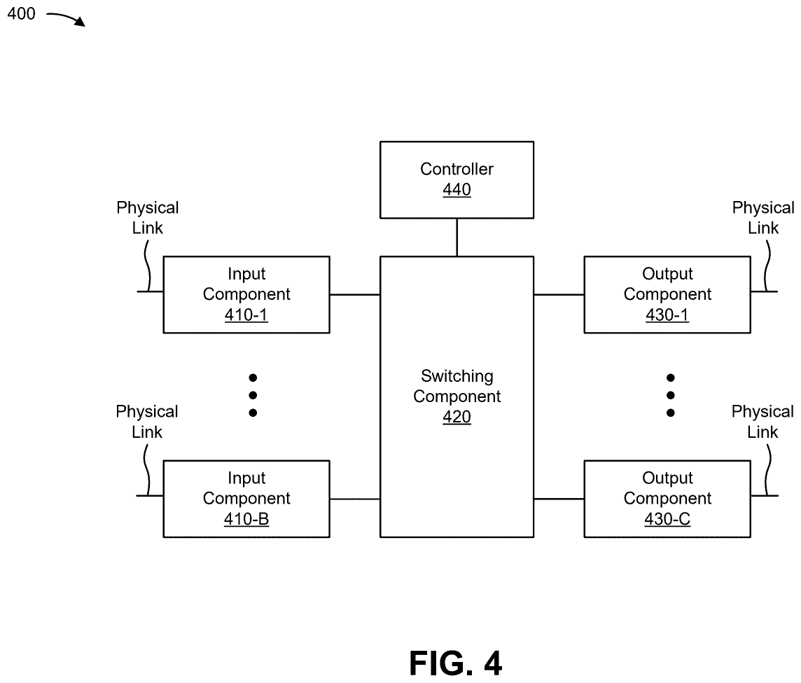

FIG. 4 is a diagram of example components of one or more devices of FIG. 2. The example components may be included in a device 400. The device 400 may correspond to the network device 230. In some implementations, the network device 230 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices. Software instructions may be read into a memory and/or storage component associated with the controller 440 from another computer-readable medium or from another device via a communication component. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

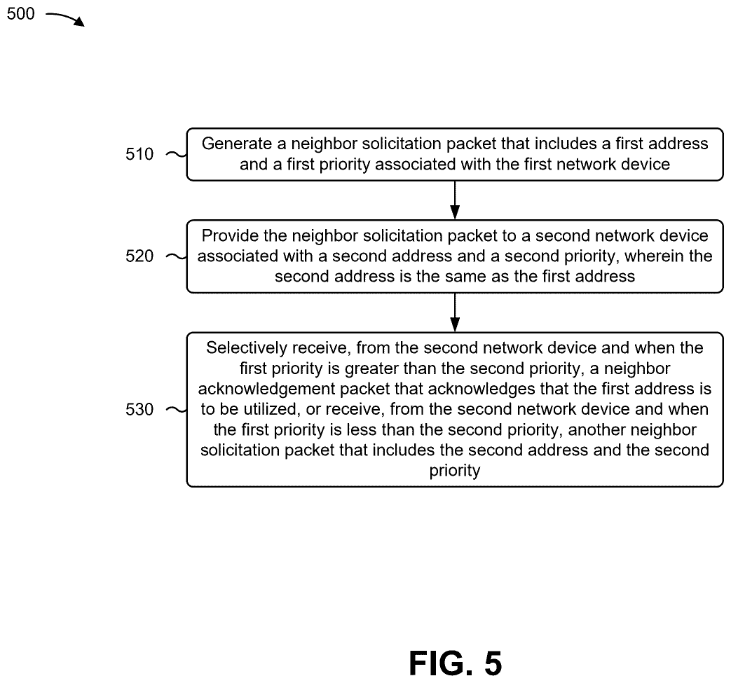

FIG. 5 is a flowchart of an example process 500 for detecting and preventing duplicate network addresses. In some implementations, one or more process blocks of FIG. 5 may be performed by a network device (e.g., the network device 230). In some implementations, one or more process blocks of FIG. 5 may be performed by another device or a group of devices separate from or including the network device, such as a user device (e.g., the user device 210), and/or the like. Additionally, or alternatively, one or more process blocks of FIG. 5 may be performed by one or more components of the device 300, such as the processor 320, the memory 330, the input component 340, the output component 350, and/or the communication component 360.

Additionally, or alternatively, one or more process blocks of FIG. 5 may be performed by one or more components of the device 400, such as the input component 410, the switching component 420, the output component 430, and/or the controller 440.

As shown in FIG. 5, process 500 may include generating a neighbor solicitation packet that includes a first address and a first priority associated with the first network device (block 510). For example, the first network device may generate a neighbor solicitation packet that includes a first address and a first priority associated with the first network device, as described above. In some implementations, the first network device is a sender network device and the second network device is a receiver network device.

As further shown in FIG. 5, process 500 may include providing the neighbor solicitation packet to a second network device associated with a second address and a second priority, wherein the second address is the same as the first address (block 520). For example, the first network device may provide the neighbor solicitation packet to a second network device associated with a second address and a second priority, wherein the second address is the same as the first address, as described above.

As further shown in FIG. 5, process 500 may include selectively receiving, from the second network device and when the first priority is greater than the second priority, a neighbor acknowledgement packet that acknowledges that the first address is to be utilized, or receiving, from the second network device and when the first priority is less than the second priority, another neighbor solicitation packet that includes the second address and the second priority (block 530). For example, the first network device may selectively receive, from the second network device and when the first priority is greater than the second priority, a neighbor acknowledgement packet that acknowledges that the first address is to be utilized, or receive, from the second network device and when the first priority is less than the second priority, another neighbor solicitation packet that includes the second address and the second priority, as described above. In some implementations, the first priority is greater than the second priority. In some implementations, when the first priority is greater than the second priority, the second address is disabled at the second network device.

In some implementations, process 500 includes enabling the first address based on receiving the neighbor acknowledgement packet from the second network device. In some implementations, process 500 includes providing one or more other neighbor solicitation packets to one or more corresponding peer network devices based on receiving the neighbor acknowledgement packet from the second network device. In some implementations, process 500 includes receiving one or more responses from the one or more corresponding peer network devices to determine whether to maintain enablement of the first address at the first network device.

In some implementations, process 500 includes comparing the first priority and the second priority based on receiving the other neighbor solicitation packet from the second network device. In some implementations, process 500 includes disabling the first address based on determining that the first priority is less than the second priority based on comparing the first priority and the second priority. In some implementations, process 500 includes generating another neighbor acknowledgement packet that acknowledges that the second address may be utilized, based on determining that the first priority is less than the second priority, based on comparing the first priority and the second priority, and providing the other neighbor acknowledgement packet to the second network device. In some implementations, the other neighbor acknowledgement packet causes the second network device to enable the second address and to provide one or more other neighbor solicitation packets to one or more corresponding peer network devices.

In some implementations, process 500 includes receiving, from the second network device and when the second network device does not support priority for duplicate address detection, another neighbor acknowledgement packet that includes a duplicate address detection message. In some implementations, process 500 includes disabling the first address based on receiving the duplicate address detection message included in the other neighbor acknowledgement packet, and reinitiating duplicate address detection, after expiration of a timer value, to determine whether to reenable the first address.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
generating, by a first network device, a neighbor solicitation packet that includes a first address and a first priority associated with the first network device;
providing, by the first network device, the neighbor solicitation packet to a second network device associated with a second address and a second priority, wherein the second address is the same as the first address; and
selectively:
receiving, by the first network device, from the second network device, and when the first priority is greater than the second priority, a neighbor acknowledgement packet that acknowledges that the first address is to be utilized, or
receiving, by the first network device, from the second network device, and when the first priority is less than the second priority, another neighbor solicitation packet that includes the second address and the second priority.

2. The method of claim 1, wherein the first priority is greater than the second priority associated with the second network device.

3. The method of claim 1, wherein the second address is disabled at the second network device.

4. The method of claim 1, further comprising:
enabling the first address based on receiving the neighbor acknowledgement packet from the second network device.

5. The method of claim 1, further comprising:
providing one or more other neighbor solicitation packets to one or more corresponding peer network devices based on receiving the neighbor acknowledgement packet from the second network device.

6. The method of claim 5, further comprising:
receiving one or more responses from the one or more corresponding peer network devices to determine whether to maintain enablement of the first address at the first network device.

7. The method of claim 1, wherein the first network device is a sender network device and the second network device is a receiver network device.

8. A first network device, comprising:
one or more memories; and
one or more processors to:
generate a neighbor solicitation packet that includes a first address and a first priority associated with the first network device;
provide the neighbor solicitation packet to a second network device associated with a second address and a second priority, wherein the second address is the same as the first address, the first network device is a sender network device, and the second network device is a receiver network device; and
selectively:
receive, from the second network device and when the first priority is greater than the second priority, a neighbor acknowledgement packet that acknowledges that the first address is to be utilized, or
receive, from the second network device and when the first priority is less than the second priority, another neighbor solicitation packet that includes the second address and the second priority.

9. The first network device of claim 8, wherein the one or more processors are further to:
compare the first priority and the second priority based on receiving the other neighbor solicitation packet from the second network device.

10. The first network device of claim 9, wherein the one or more processors are further to:
disable the first address based on determining that the first priority is less than the second priority based on comparing the first priority and the second priority.

11. The first network device of claim 10, wherein the one or more processors are further to:
generate another neighbor acknowledgement packet that acknowledges that the second address may be utilized based on determining that the first priority is less than the second priority based on comparing the first priority and the second priority; and
provide the other neighbor acknowledgement packet to the second network device.

12. The first network device of claim 11, wherein the other neighbor acknowledgement packet causes the second network device to enable the second address and to provide one or more other neighbor solicitation packets to one or more corresponding peer network devices.

13. The first network device of claim 8, wherein the one or more processors are further to:
receive, from the second network device and when the second network device does not support priority for duplicate address detection, another neighbor acknowledgement packet that includes a duplicate address detection message.

14. The first network device of claim 13, wherein the one or more processors are further to:
disable the first address based on receiving the duplicate address detection message included in the other neighbor acknowledgement packet; and
reinitiate duplicate address detection, after expiration of a timer value, to determine whether to reenable the first address.

15. A non-transitory computer-readable medium storing a set of instructions, the set of instructions comprising:
one or more instructions that, when executed by one or more processors of a first network device, cause the first network device to:
generate a neighbor solicitation packet that includes a first address and a first priority associated with the first network device;
provide the neighbor solicitation packet to a second network device associated with a second address and a second priority, wherein the second address is the same as the first address; and
selectively:
receive, from the second network device and when the first priority is greater than the second priority, a neighbor acknowledgement packet that acknowledges that the first address is to be utilized, and enable the first address based on receiving the neighbor acknowledgement packet from the second network device, or
receive, from the second network device and when the first priority is less than the second priority, another neighbor solicitation packet that includes the second address and the second priority.

16. The non-transitory computer-readable medium of claim 15, wherein the one or more instructions further cause the first network device to:
provide one or more other neighbor solicitation packets to one or more corresponding peer network devices based on receiving the neighbor acknowledgement packet from the second network device.

17. The non-transitory computer-readable medium of claim 16, wherein the one or more instructions further cause the first network device to:
receive one or more responses from the one or more corresponding peer network devices to determine whether to maintain enablement of the first address at the first network device.

18. The non-transitory computer-readable medium of claim 15, wherein the one or more instructions further cause the first network device to:
compare the first priority and the second priority based on receiving the other neighbor solicitation packet from the second network device; and
disable the first address based on determining that the first priority is less than the second priority based on comparing the first priority and the second priority.

19. The non-transitory computer-readable medium of claim 18, wherein the one or more instructions further cause the first network device to:
generate another neighbor acknowledgement packet that acknowledges that the second address may be utilized based on determining that the first priority is less than the second priority based on comparing the first priority and the second priority; and
provide the other neighbor acknowledgement packet to the second network device.

20. The non-transitory computer-readable medium of claim 15, wherein the one or more instructions further cause the first network device to:
receive, from the second network device and when the second network device does not support priority for duplicate address detection, another neighbor acknowledgement packet that includes a duplicate address detection message;
disable the first address based on receiving the duplicate address detection message included in the other neighbor acknowledgement packet; and
reinitiate duplicate address detection, after expiration of a timer value, to determine whether to reenable the first address.
